(19) United States
(12) Patent Application Publication
(10) Pub. No.: US 2016/0365759 A1
(43) Pub. Date: Dec. 15, 2016

(54) MAGNETIC ENERGY GENERATION DEVICE

(71) Applicants: Sheng Rong LIN, Tainan (TW); Tzu-Chien LIN, Tainan (TW)

(72) Inventors: Sheng Rong LIN, Tainan (TW); Tzu-Chien LIN, Tainan (TW)

(21) Appl. No.: 14/736,280

(22) Filed: Jun. 11, 2015

(51) Int. Cl. H02K 1/17; H02K 1/27

(52) U.S. Cl. CPC H02K 1/17; H02K 1/27; Y10S 74/09; H02K 53/00

(57) ABSTRACT

A magnetic energy generation device includes at least two magnetic coil units, two magnetic control units and a rotating unit located in a generator. Each of the magnetic control units is connected with a switchgear, and includes inner magnets, the isolation member and outer magnets. A groove is formed between the inner magnets and the outer magnets of each of the two magnetic control units. The isolation member is located in the groove. The S-pole of each of the inner magnets is located corresponding to the S-pole of the outer magnet corresponding thereto. The N-pole of each of the inner magnets is located corresponding to the N-pole of the outer magnet corresponding thereto so as to have magnetic repelling action to rotate the rotating unit when the isolation members are moved. Magnetic induction is formed between the stator and the rotors to generate induction current.

### BACKGROUND OF THE INVENTION

1. Fields of the invention

The present invention relates to a magnetic energy generation device, and more particularly, to a magnetic energy generation device using the principle of magnets repelling to rotate a shaft so as to create induction current.

2. Descriptions of Related Art

The conventional power generator generally comprises a stator unit and a rotor unit, wherein the stator is composed of an iron core wrapped with coils, and the rotor unit is composed of an iron core and a magnet. By using wind power, thermal power or hydraulic power as the driving power to drive the power generator, electromagnetic induction processes happen between the stator unit and the rotor unit so as to generate induction current within the coil of the stator unit. However, the efficiency is very limited, the improvement method is to increase the size or number of the stator unit and the rotor unit, or to install multiple generators. The improvement method includes a high cost, and air pollution because of thermal power supply. If power is produced by water or wind, a big structure and space would be occupied. None of the conventional ways of power generation could be satisfied.

The present invention intends to provide a magnetic energy generation device to eliminate the shortcomings mentioned above.

### SUMMARY OF THE INVENTION

The present invention relates to a magnetic energy generation device and comprises a generator in which at least two magnetic coil units, two magnetic control units and a rotating unit are located. The at least two magnetic coil units are each have a stator and two rotors. The two magnetic control units are connected to two ends of the generator. Each magnetic control unit is connected with a switchgear and has inner magnets, an isolation member and outer magnets. The switch controls the isolation member. A groove is formed between the inner magnets and the outer magnets of each of the two magnetic control units. The isolation member is located in the groove. The S-pole of each of the inner magnets is located corresponding to the S-pole of the outer magnet corresponding thereto. The N-pole of each of the inner magnets is located corresponding to the N-pole of the outer magnet corresponding thereto. The rotating unit extends through the at least two magnetic coil units, the two magnetic control units and the generator. Bearings are mounted to and support the rotating unit.

Preferably, the generator has two recesses defined in the outside thereof The two recesses respectively communicate with the two grooves, and the switchgear is movable in the recess corresponding thereto and protrudes out from the recess.

The primary object of the present invention is to provide a magnetic energy generation device which uses the switchgears to control the isolation members to cause magnetic repelling between the inner magnets and the outer magnets to rotate the rotating unit. Magnetic induction is formed between the stator and the rotors of the at least two magnetic coil units to generate induction current.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the arrangement of the parts of the magnetic energy generation device of the present invention;

FIG. 2 is a cross sectional view to show the magnetic energy generation device of the present invention, and

FIG. 3 is a cross sectional view to show that the switchgears are moved to activate the rotating unit to rotate.

### DETAILED DESCRIPTION OF THE PREFERRED EMBODIMENT

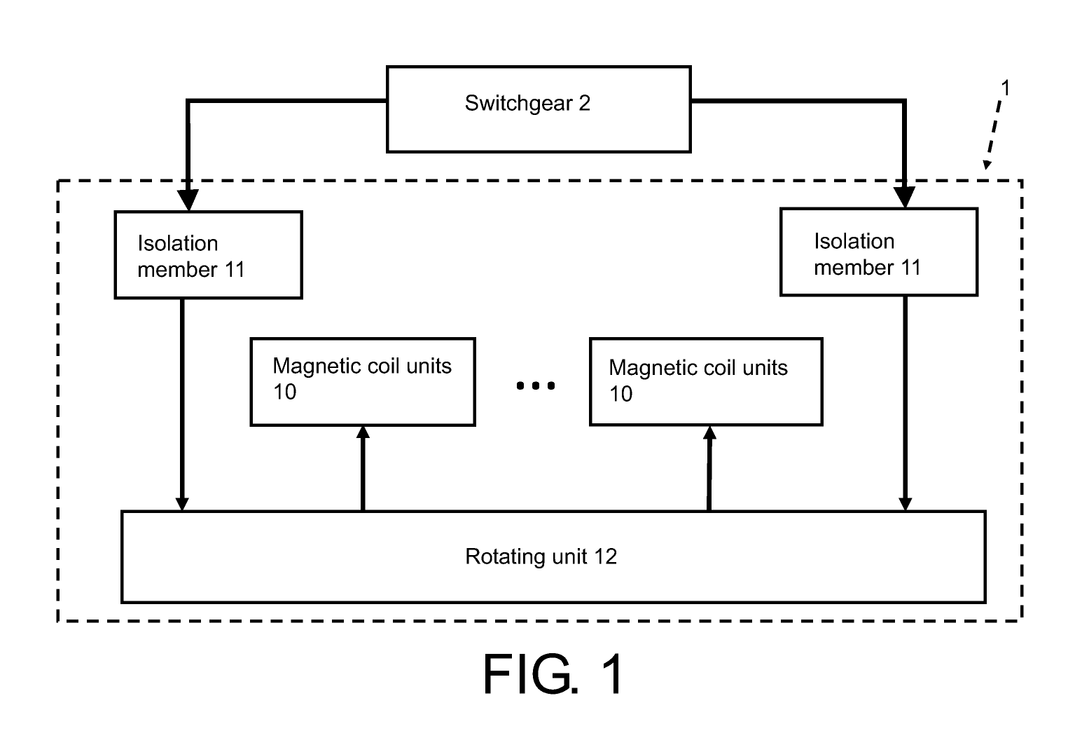

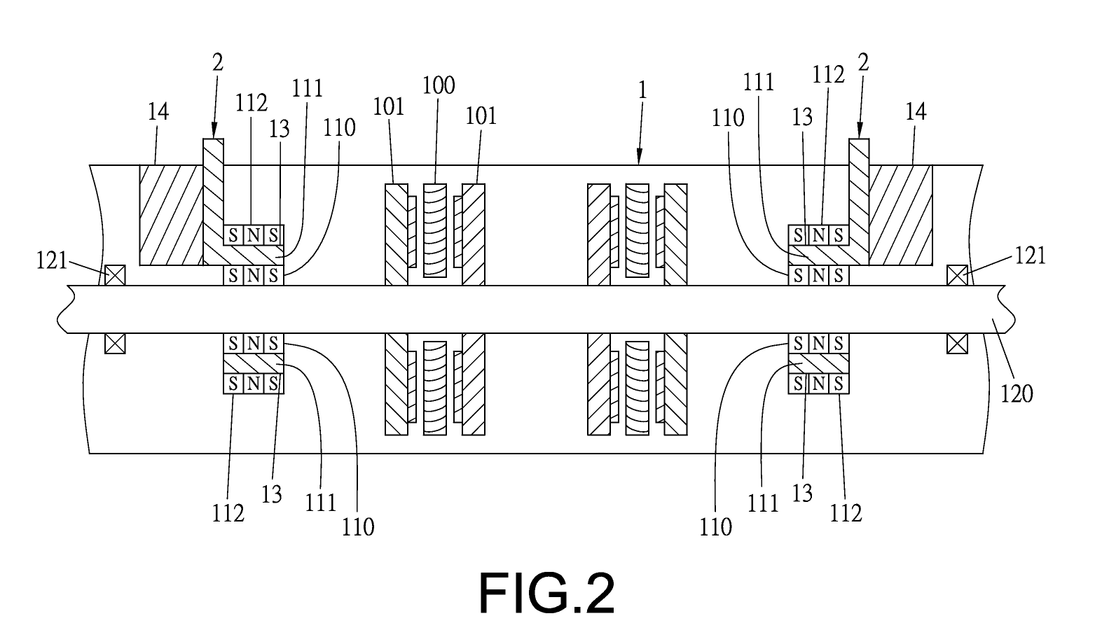

Referring to FIGS. 1 and 2, the magnetic energy generation device of the present invention comprises a generator 1 in which at least two magnetic coil units 10, two magnetic control units 11 and a rotating unit 12 are located. The at least two magnetic coil units 10 each have a stator 100 and two rotors 101, wherein the stator 100 has induction coils which are able to generate induction current. The rotors 101 have electro-magnetic induction feature. The two magnetic control units 11 are connected to the two ends of the generator 1. Each magnetic control unit 11 is connected with a switchgear 2 and has inner magnets 110, an isolation member 111 and outer magnets 112. The switchgear 2 is connected with the isolation member 111. A groove 13 is formed between the inner magnets 110 and the outer magnets 112 of each of the two magnetic control units 11. The isolation member 111 is located in the groove 13. The S-pole of each of the inner magnets 110 is located corresponding to the S-pole of the outer magnet 112 corresponding thereto. The N-pole of each of the inner magnets 110 is located corresponding to the N-pole of the outer magnet 112 corresponding thereto. By this arrangement, magnetic repelling happens when the isolation members 111 are removed. The rotating unit 12 extends through the at least two magnetic coil units 10, the two magnetic control units 11 and the generator 1. Two bearings 121 are mounted to and support the rotating unit 12. The generator 1 has two recesses 14 defined in the outside thereof The two recesses 14 respectively communicate with the two grooves 13. The switchgear 2 is electrically connected to the magnetic control unit 11 corresponding thereto so as to be control the isolation member 111 of the magnetic control unit 11.

When assembling the magnetic energy generation device, the at least two magnetic coil units 10 are installed in the generator 1, and each magnetic coil unit 10 has one stator 100 located between the two rotors 101. The two magnetic control units 11 are connected to the two ends of the generator 1. Each magnetic control unit 11 has inner magnets 110 and outer magnets 112 between which a groove 13 is formed. The S-pole of each of the inner magnets 110 is located corresponding to the S-pole of the outer magnet 112 corresponding thereto. The N-pole of each of the inner magnets 110 is located corresponding to the N-pole of the outer magnet 112 corresponding thereto. By this arrangement, magnetic repelling happens between the inner and outer magnets 110, 112. The rotating unit 12 extends through the at least two magnetic coil units 10, the two magnetic control units 11 and the generator 1. Specifically, the shaft 120 of the rotating unit 12 extends through the rotors 101 and the inner magnets 110. The switchgear 2 is electrically connected to the magnetic control unit 11 corresponding thereto so as to control the isolation member 111. Alternatively, the switchgear 2 and the isolation member 111 are integrally installed in the recess 14 and protrude beyond the recess 14.

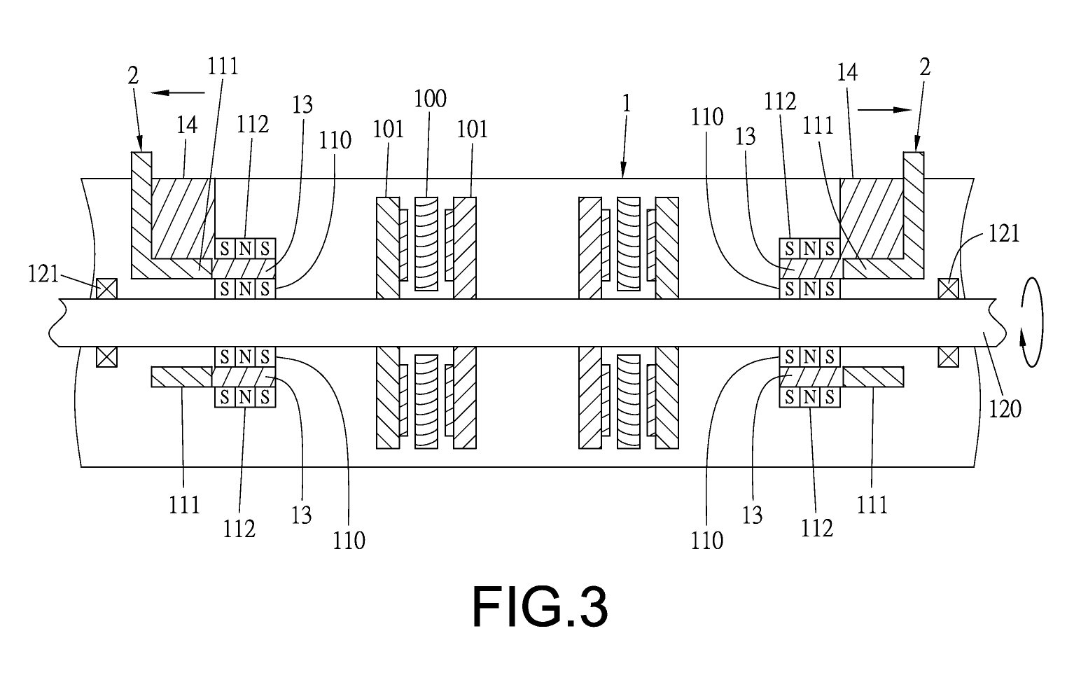

When in use, as shown in FIGS. 1 and 3, the switchgears 2 are manually operated to move along the recesses 14, and the isolation members 111 are moved along the grooves 13 between the inner and outer magnets 110, 112. Therefore, the S-pole of each of the inner magnets 110 faces the S-pole of the outer magnet 112 corresponding thereto. The N-pole of each of the inner magnets 110 faces the N-pole of the outer magnet 112 corresponding thereto. Magnetic repelling happens between the inner and outer magnets 110, 112 so as to rotate the shaft 120 of the rotating unit 12. The stators 100 and the rotors 101 of the at least two magnetic coil units 10 generate induction current.

Alternatively, by electrically controlling the switchgears 2 which are electrically connected to the magnetic control units 11 so as to move the isolation members 111 along the grooves 13 and the recesses 14, such that the S-pole of each of the inner magnets 110 faces the S-pole of the outer magnet 112 corresponding thereto. The N-pole of each of the inner magnets 110 faces the N-pole of the outer magnet 112 corresponding thereto. Magnetic repelling happens between the inner and outer magnets 110, 112 so as to rotate the shaft 120 of the rotating unit 12. The stators 100 and the rotors 101 of the at least two magnetic coil units 10 generate induction current. Therefore, by operating the switchgears 2 to move the isolation members 111, magnetic repelling happens between the inner and outer magnets 110, 112 so as to rotate the shaft 120 of the rotating unit 12. The stators 100 and the rotors 101 of the at least two magnetic coil units 10 generate induction current.

The advantages of the present invention are that the present invention only needs one generator 1 with at least two magnetic coil units 10, two magnetic control units 11 and one rotating unit 12 located therein, and the isolation members 111 are controlled by the switchgears 2. No more sets of power generation devices need to be purchased. The efficiency of power generation is high and the cost is low. The present invention is compact and light, can be used in factors or homes.

By using the principle of magnetic repelling of the magnets, no electric power is needed. There will be no air pollution as that happens when using thermal power. There will be no huge equipment needed as that happens when using hydraulic power or wind power.

By moving the isolation members 111 which are controlled by the switchgears, magnetic repelling happens between the inner and outer magnets 110, 112 of the magnetic control units 11 so as to rotate the shaft 120 of the rotating unit 12. The stators 100 and the rotors 101 of the at least two magnetic coil units 10 generate induction current. When the isolation members 111 are controlled by insolate the inner and outer magnets 110, 112 of the magnetic control units 11, the shaft 120 of the rotating unit 12 is stopped. No induction current is generated by the stators 100 and the rotors 101 of the at least two magnetic coil units 10. The operation of the magnetic energy generation device is easy and convenient.

While we have shown and described the embodiment in accordance with the present invention, it should be clear to those skilled in the art that further embodiments may be made without departing from the scope of the present invention.

What is claimed is:

1. A magnetic energy generation device comprising:
a generator, at least two magnetic coil units, two magnetic control units and a rotating unit, the at least two magnetic coil units located in the generator and having a stator and two rotors, the two magnetic control units located in the generator and connected to two ends of the generator, each magnetic control unit connected with a switchgear and having inner magnets, an isolation member and outer magnets, the switch controlling the isolation member, a groove formed between the inner magnets and the outer magnets of each of the two magnetic control units, the isolation member located in the groove, an S-pole of each of the inner magnets being located corresponding to an S-pole of the outer magnet corresponding thereto, a N-pole of each of the inner magnets being located corresponding to a N-pole of the outer magnet corresponding thereto, and
the rotating unit extending through the at least two magnetic coil units, the two magnetic control units and the generator, bearings mounted to and supporting the rotating unit.

2. The magnetic energy generation device as claimed in claim 1, wherein the generator has two recesses defined in an outside thereof, the two recesses respectively communicate with the two grooves, the switchgear is movable in the recess corresponding thereto and protrudes beyond from the recess.
